(19) United States
(12) Patent Application Publication
(10) Pub. No.: US 2009/0019022 A1
(43) Pub. Date: Jan. 15, 2009

(54) RULES-BASED DATA MINING

(75) Inventors: Gregory Schallert, Fort Myers, FL (US); Sungho Maeung, Fort Myers, FL (US); Juliana Nunes, Fort Myers, FL (US); Borshin Wang, San Diego, CA (US); Eric Danielson, Seattle, WA (US)

Correspondence Address: MIRICK, O'CONNELL, DEMALLIE & LOUGEE, LLP, 1700 WEST PARK DRIVE, WESTBOROUGH, MA, 01581, US

(73) Assignee: Dawning Technologies, Inc., Fort Myers, FL (US)

(21) Appl. No.: 12/173,757

(22) Filed: Jul. 15, 2008

Related U.S. Application Data
(60) Provisional application No. 60/949,871, filed on Jul. 15, 2007.

(51) Int. Cl. G06F 17/30; G06F 3/048

(52) U.S. Cl. 707/4; 715/700; 707/E17.136

(57) ABSTRACT

The present invention provides systems and methods for retrieving, modifying, and managing data in a database without knowing the underlying database schema. In preferred embodiments, the present invention provides a consistent Graphical User Interface (GUI) to allow an end user to interact with the underlying database without programming or writing Structured Query Language (SQL) or Hibernate Query Language (HQL) statements. The present invention improves upon existing database connectivity tools by adding a level of abstraction on top of the Open Database Connectivity (ODBC) or Java Database Connectivity (JDBC) and object/relational persistence and query service layers known in the art. In additional embodiments, the present invention provides an API to allow a computer program to interact with the underlying database, and allows the computer program to execute queries and integrate the results of these queries into the computer program's internal system.

### CROSS REFERENCE TO RELATED APPLICATION

This application claims priority of provisional patent application Ser. No. 60/949,871, filed on Jul. 15, 2007, the entire disclosure of which is incorporated herein by reference.

### BACKGROUND OF THE INVENTION

SQL, or Structured Query Language, is a computer language used to retrieve, modify, and manage data in a relational database management system (DBMS). While SQL has been standardized by both ANSI (American National Standards Institute) and ISO (International Organization for Standardization), most database providers, including Oracle Corporation and Microsoft, provide custom features, which in turn make use of custom SQL statements. As a result, database programmers must be familiar with the custom SQL statements for each new database, in addition to each database's structure or schema, in terms of its unique table and column names.

ODBC, or Open Database Connectivity, was developed to add a layer of abstraction to databases, by making database programming independent of programming languages, database systems, and operating systems. ODBC provides a standard software API (Application Programming Interface) for using SQL statements to access data. Similarly, Java Database Connectivity (JDBC) is an API for the Java programming language that provides methods for querying and updating data in relational database.

As shown in FIGS. 1A and 1B, two different databases, Data Base A 105 and Data Base B 110, may both be accessed through ODBC or JDBC Driver 115, and the results may be displayed using User Interface Code 130. However, because Data Base A 105 may have a different schema and may use different database-specific structures from Data Base B 110, database programmers would have to write custom software to interface with each of the databases, specifically Custom SQL Code and Statements 120 for Data Base A 105, and Custom SQL Code and Statements 125 for Data Base B 125. An additional layer of database abstraction can be provided by an object/relational persistence and query service. One such commercially available service is Hibernate, an object-oriented mapping (ORM) software solution, available as open source software and distributed under the GNU Lesser General Public License (LGPL). The invention is not limited to the use of Hibernate, however, and other object/relational persistence and query services, whether commercially available or proprietary, may be used with the present invention.

An object/relational persistence and query service such as Hibernate provides a framework for mapping an object-oriented domain model to a traditional relational database, allowing a programmer to perform operations on objects that are independent of the database. As a result, instead of writing SQL statements to operate on tables and columns, a database programmer using an object/relational persistence and query service such as Hibernate writes HQL (Hibernate Query Language) statements to operate on objects. This additional layer of abstraction eliminates the need to know and use custom SQL statements. As a result, a programmer only needs to know objects, which allows him or her to write significantly less code for each database.

As shown in FIGS. 2A and 2B, two different databases, Data Base A 105 and Data Base B 110, may both be accessed through Hibernate Driver 215, and the results may be displayed using User Interface Code 130. However, as with ODBC and JDBC, because Data Base A 105 may have a different schema and may use different database-specific structures than Data Base B 110, database programmers would have to write custom software to interface with each of the databases, specifically Custom Code using Hibernate 220 for Data Base A 105 and Custom Code using Hibernate 225 for Data Base B 125. Note, also, that an object/relational persistence and query service such as Hibernate is designed only to reduce the amount of code that a programmer may have to write, but has no effect on an end user, who may still need to know the details of the database schema.

There is a need in the art, then, for another layer of abstraction, such that an end user, and not a database programmer, may retrieve, modify, and manage data in a database, without knowing the specifics of the underlying database schema. In addition, rather than having to write database programs, there is a need in the art for such a layer of abstraction to be accessed through a graphical user interface (GUI) or through an application programming interface (API).

### SUMMARY OF THE INVENTION

The present invention provides systems and methods for retrieving, modifying, and managing data in a database without knowing the underlying database schema. In preferred embodiments, the present invention provides a consistent GUI to allow an end user to interact with the underlying database without programming or writing SQL or HQL statements. In additional embodiments, the present invention provides an API to allow a computer program to interact with the underlying database, and allows the computer program to execute queries and integrate the results of these queries into the computer program's internal system. The types of computer programs that can interact with the underlying database are not limited to any particular application or programming language, and can be of any type, such as a Windows DLL, or a third-party database application.

The present invention improves upon existing database connectivity tools by adding a level of abstraction on top of the ODBC and object/relational persistence and query service layers known in the art.

In preferred embodiments, the present invention comprises an engine or module to translate, or “reverse-engineer” the underlying database schema into a set of objects and related variables. These objects and variables are further translated into aliases, which are presented to the end user through the GUI or to a computer program through the API. The GUI allows a user to change the aliases, query the database, build custom rules and corresponding database actions, and view the results of the queries and resulting database actions. Similarly, the API allows a computer program to change the aliases, query the database, build custom rules and corresponding database actions, and use the results of the queries and resulting database actions.

For example, a database may have a table called “Patient,” which in turn has three columns, “Sample,” “Patient Name,” and “Social Security Number.” Further, the “Sample” column in the “Patient” table may be a link to a table named “Sample,” with a column called “ID.” The present invention reverse-engineers the tables and columns into a join path, Patient->Sample->ID, or, in dot notation, Patient.Sample.ID, and presents the alias “ID” to the user via the GUI. The dot notation is used to represent the tables and their structure, including the columns contained within the tables. The user may use the GUI to change the alias, for example, to “Specimen ID,” and query the database. As a result, the user does not need to know the underlying database schema. Further, even if the schema changes in the future, the user's defined queries will still be operational as long as the same alias is used. Similarly, a computer program may use the API to change the alias and/or query the database, such that the computer program does not need to know the underlying database schema, and the queries will still be operational as long as the same alias is used, even if the schema changes in the future. In other aspects, the present invention allows an end user to create and save custom rules and actions as templates for new rules and actions. Rules and actions may also be saved in XML (Extensible Markup Language) and stored in a file or placed in a data stream to be used with other applications, such as commercial or proprietary report-generating programs, through the use of an API.

In a preferred embodiment, the present invention includes a system for forming a statement for a database, where the system comprises a database stored on a computer-readable medium and having a schema; a database connection module, for translating at least a portion of the schema into one or more objects and variables, where at least one object is associated with at least one variable, and creating a corresponding alias for the object and associated variable; and a user interface module, for displaying the corresponding alias, and accepting at least one user input associated with the corresponding alias; wherein the database connection module receives the user input, and forms a database statement from the corresponding alias and the user input.

In an aspect, the database is a relational database.

In additional aspects, the database statement is a Hibernate Query Language (HQL) statement or an Extensible Markup Language (XML) statement.

In still another aspect, the user interface module is a graphical user interface (GUI) module.

In a preferred embodiment, the present invention includes a method for forming a statement for a database, where the database has at least one table and the table has at least one column, comprising the steps of creating an object for the table; determining a variable for the object, where the variable corresponds to the column in the table; constructing a join path using the object and the variable; creating an alias for the join path; accepting at least one input associated with the alias; and forming a database statement from the input.

In an aspect, the object created is a Plain Old Java Object (POJO).

In another aspect, the variable for the object is determined using the object's metadata.

In yet another aspect, the database statement is a Hibernate Query Language (HQL) statement or an Extensible Markup Language (XML) statement.

In an additional aspect, the input comprises one or more input fields and one or more input values, and the database statement is a database query statement formed from the input fields and the input values.

In yet another aspect, the database query statement is formed from the input and the join path associated with the alias.

In another embodiment, the method for forming a statement for a database further comprises the step of identifying a data type for the variable, and using the data type to create the join path.

In additional embodiments, the method for forming a statement for a database further comprises the step of displaying the alias and/or displaying the join path.

In a preferred embodiment, the invention provides a computer-readable medium comprising one or more computer-executable instructions for creating an object for a table in a database; determining a variable for the object, where the variable corresponds to a column in the table; constructing a join path using the object and the variable; creating an alias for the join path; accepting at least one input associated with the alias; and forming a database statement from the input.

In an additional embodiment, the computer-readable medium further comprises computer instructions for displaying the alias and forming the database statement from the alias.

In a preferred embodiment, the invention provides a computer system comprising one or more computer processors, system memory, and one or more physical computer-readable media having stored there on computer-executable instructions, which, when executed, perform a method comprising creating an object for a table in a database; determining a variable for the object, where the variable corresponds to a column in the table; constructing a join path using the object and the variable; creating an alias for the join path; accepting at least one input associated with the alias; and forming a database statement from the input.

In an additional embodiment, the method performed by the computer-executable instructions further comprises the operation of displaying the alias and forming the database statement from the alias.

In another embodiment, the invention includes a system for forming a statement for a database comprising a database stored on a computer-readable medium and having a schema; a database connection module, for translating at least a portion of the schema into one or more objects and variables, where at least one object is associated with at least one variable, and creating a corresponding alias for the object and associated variable; and an application programming interface, for providing the corresponding alias to a computer program, and accepting a query associated with the corresponding alias from the computer program; wherein the database connection module receives the query, and forms a database statement from the corresponding alias and the query.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIGS. 1A and 1B are prior art block diagrams of the components used to provide a user interface to a database via ODBC or JDBC;

FIGS. 2A and 2B are prior art block diagrams of the components used to provide a user interface to a database via an object/relational persistence and query service such as Hibernate;

FIG. 3 is a diagram of a system for rules-based data mining, in accordance with a preferred embodiment of the present invention;

FIGS. 4A, 4B and 4C are block diagrams of the components used to provide a user interface to a database, in accordance with the rules-based data mining system of FIG. 3;

FIG. 5 is a sample prior art database table structure;

FIG. 6 shows the objects and variables created by an object/relational persistence and query service such as Hibernate for each of the tables of FIG. 5;

FIG. 7 illustrates the process for identifying class types from the objects and variables of FIG. 6;

FIG. 8 is a screen shot of the Database Settings user interface display in accordance with the rules-based data mining system of FIG. 3;

FIG. 9 is a screen shot of the Reverse Engineer Dialogue user interface display in accordance with the rules-based data mining system of FIG. 3;

FIG. 10 is a screen shot of the Auto-populate Window user interface display in accordance with the rules-based data mining system of FIG. 3;

FIG. 11 is a screen shot of the Alias Selection user interface display in accordance with the rules-based data mining system of FIG. 3;

FIG. 12 is a screen shot of the Filter Selection user interface display in accordance with the rules-based data mining system of FIG. 3;

FIG. 13 is a screen shot of the Extra Configuration Window user interface display in accordance with the rules-based data mining system of FIG. 3;

FIG. 14 is a screen shot of the Dynamic Query Wizard: First View user interface display in accordance with the rules-based data mining system of FIG. 3;

FIG. 15 is a screen shot of the Add Dynamic Query Wizard View user interface display in accordance with the rules-based data mining system of FIG. 3;

FIG. 16 is a screen shot of the Query Title and Description user interface display in accordance with the rules-based data mining system of FIG. 3;

FIG. 17 is a screen shot of the Query Tool Wizard user interface display in accordance with the rules-based data mining system of FIG. 3;

FIG. 18 is a screen shot of the Select Columns user interface display in accordance with the rules-based data mining system of FIG. 3;

FIG. 19 is a screen shot of the Filter Setting user interface display in accordance with the rules-based data mining system of FIG. 3;

FIG. 20 is a screen shot of the Sub Query Fields user interface display in accordance with the rules-based data mining system of FIG. 3;

FIG. 21 is a screen shot of the Single Query user interface display in accordance with the rules-based data mining system of FIG. 3;

FIG. 22 is a screen shot of the List Query user interface display in accordance with the rules-based data mining system of FIG. 3;

FIG. 23 is a screen shot of the Range Query user interface display in accordance with the rules-based data mining system of FIG. 3;

FIG. 24 is a screen shot of the Date Query user interface display in accordance with the rules-based data mining system of FIG. 3;

FIG. 25 is a screen shot of the Delta Check Query user interface display in accordance with the rules-based data mining system of FIG. 3;

FIG. 26 is a screen shot of the Repeated Test Query user interface display in accordance with the rules-based data mining system of FIG. 3;

FIG. 27 is a screen shot of the Save Options user interface display in accordance with the rules-based data mining system of FIG. 3;

FIG. 28 is a screen shot of the True Action Wizard user interface display in accordance with the rules-based data mining system of FIG. 3;

FIG. 29 is a screen shot of the Action Tool Wizard user interface display in accordance with the rules-based data mining system of FIG. 3;

FIG. 30 is a screen shot of the Insert Action user interface display in accordance with the rules-based data mining system of FIG. 3;

FIG. 31 is a screen shot of the Update Action user interface display in accordance with the rules-based data mining system of FIG. 3;

FIG. 32 is a screen shot of the Delete Action user interface display in accordance with the rules-based data mining system of FIG. 3;

FIG. 33 is a screen shot of the Save Options user interface display in accordance with the rules-based data mining system of FIG. 3;

FIG. 34 is a screen shot of the False Action Wizard user interface display in accordance with the rules-based data mining system of FIG. 3;

FIG. 35 is a screen shot of the Template Wizard user interface display in accordance with the rules-based data mining system of FIG. 3;

FIG. 36 is a screen shot of the Modify Template Wizard user interface display in accordance with the rules-based data mining system of FIG. 3; and

FIG. 37 is a screen shot of the Statistics View user interface display in accordance with the rules-based data mining system of FIG. 3.

### DEFINITIONS

The following terms used in this specification are defined as follows:

As used herein, an application programming interface (API) is a set of functions or procedures that an application, operating system, or library provides to support requests made by other computer programs.

As used herein, a database is an electronically-stored collection of data.

As used herein, dot notation is a system adapted from the Object-Oriented Programming paradigm that is used to express objects, their internal objects and variables, and their attributes by using a series of dots. For example, a person has a name, and a name has a last name and a first name. In dot notation, a person with the name John Smith could be expressed as Person.Name.Last=Smith, and Person.Name.First=John.

As used herein, a module is a self-contained hardware or software component that interacts with a larger system.

As used herein, a schema is a description of the structure of a database and the relationship between the elements of the database.

As used herein, a rule is an SQL statement, or a statement generated by an object/relational persistence and query service such as Hibernate, that is determined to be “true” or “false” depending upon whether the result set is empty.

As used herein, an action is an SQL statement, or a statement generated by an object/relational persistence and query service such as Hibernate, that acts upon the data returned by a rule.

### DETAILED DESCRIPTION OF THE INVENTION

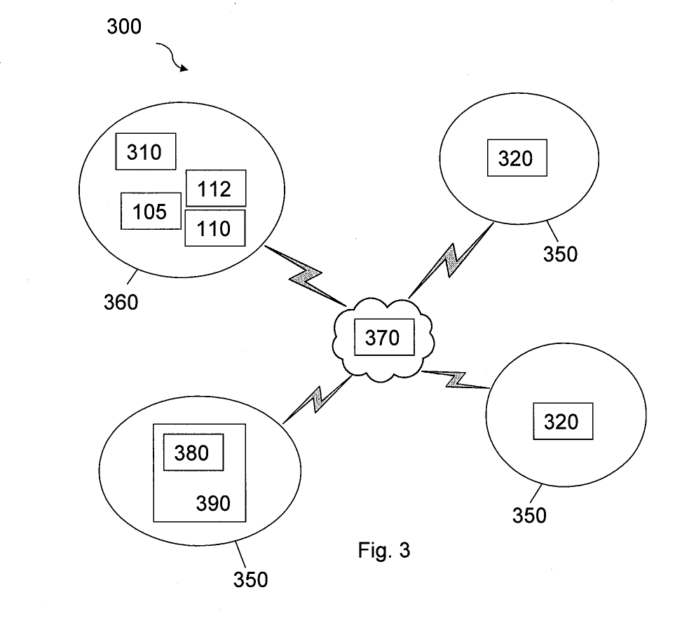

A simplified block diagram of a preferred embodiment of the invention is shown in FIG. 3, in which Data Mining System 300 runs in a client-server computer network. Client-server computer networks are well known in the art. In a preferred embodiment, one or more Client Computers 350 connects to one or more Server Computers 360 through a network 370, such as the Internet. The present invention is not limited to this configuration, however, and in alternative embodiments, Data Mining System 300 may run as a standalone application on a desktop or laptop computer; or on multiple computers connected via a network. In an alternative embodiment, Data Mining System may configured to run on one or more computers connected via a local network, such as hospital MIS (Management Information System).

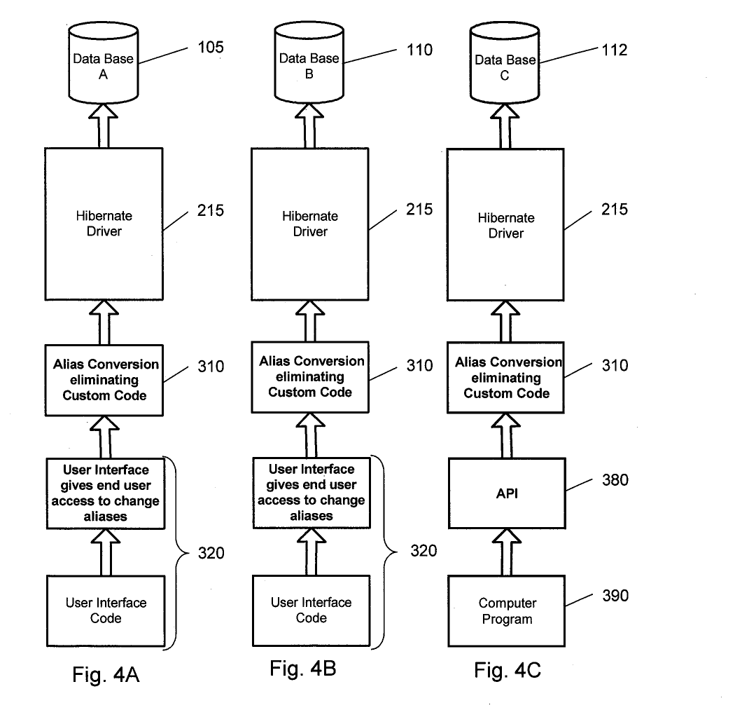

With further reference to FIG. 3, and as shown in FIGS. 4A, 4B, and 4C, in a preferred embodiment, the present invention comprises two modules, the Database Connection Engine module 310, resident on Server Computer 360 and the GUI module 320, resident on Client Computer 350. In alternative embodiments, the present invention also comprises an API 380, which may be used by a computer program 390 to interact with Database Connection Engine module 310. In a preferred embodiment, the underlying database, which may be Data Base A 105 and/or Data Base B 110 and/or Data Base 112, is also resident on Server Computer 360.

### I. Database Connection Engine

With further reference to FIGS. 3 and 4A, 4B, and 4C in a preferred embodiment, Database Connection Engine module 310 performs two primary functions. First, Database Connection Engine module 310 translates or “reverse-engineers” the underlying database schema into a set of objects and related variables, and then further translates these objects and variables into aliases. The resulting aliases are displayed to, and may be modified by, an end user through GUI module 320 or provided to a computer program 390 through the use of an API 380. Second, Database Connection Engine module 310 accepts and executes end user requests through GUI module 320 or from computer program 390, through the use of an API 380, to create HQL statements from aliases. These statements are presented in GUI module 320 as Rules and Actions and are used to retrieve, modify, manage and display the data in the underlying database.

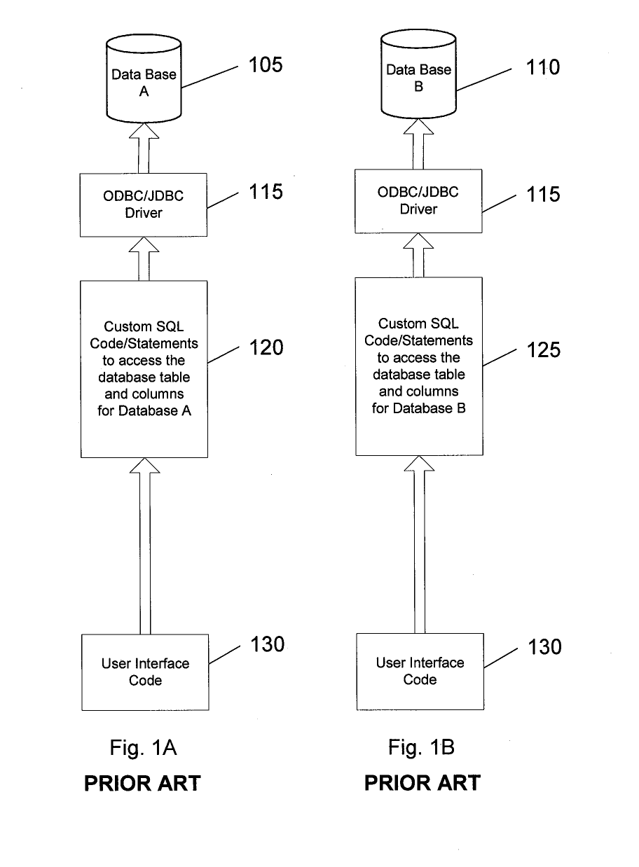

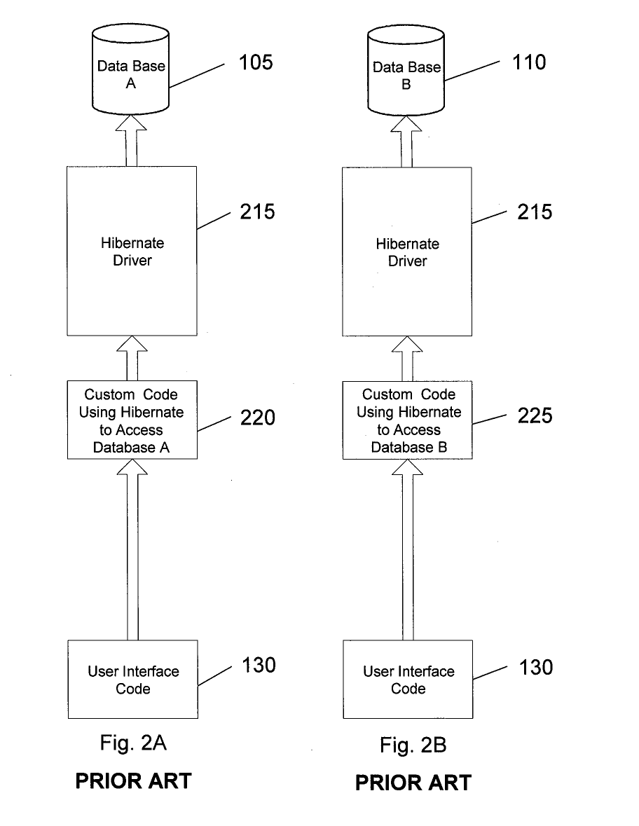

As shown in FIGS. 4A and 4B, two different databases, Data Base A 105 and Data Base B 110, may both be accessed through Hibernate Driver 215, and the results may be displayed using User Interface 320. However, even though Data Base A 105 may have a different schema and may use different database-specific structures than Data Base B 110, Alias Conversion 310 eliminates the need for database programmers to write custom software to interface with each of the databases, unlike the prior art examples shown in FIGS. 1A and 1B, and 2A and 2B. Similarly, as shown in FIG. 4C, API 380 and computer program 390 may be used to access the underlying Data Base 112 through Alias Conversion 310.

1. Database Translation/Reverse-Engineering

The Database Translation/Reverse-Engineering function is described herein through the use of examples. The present invention, however, is not limited to these examples.

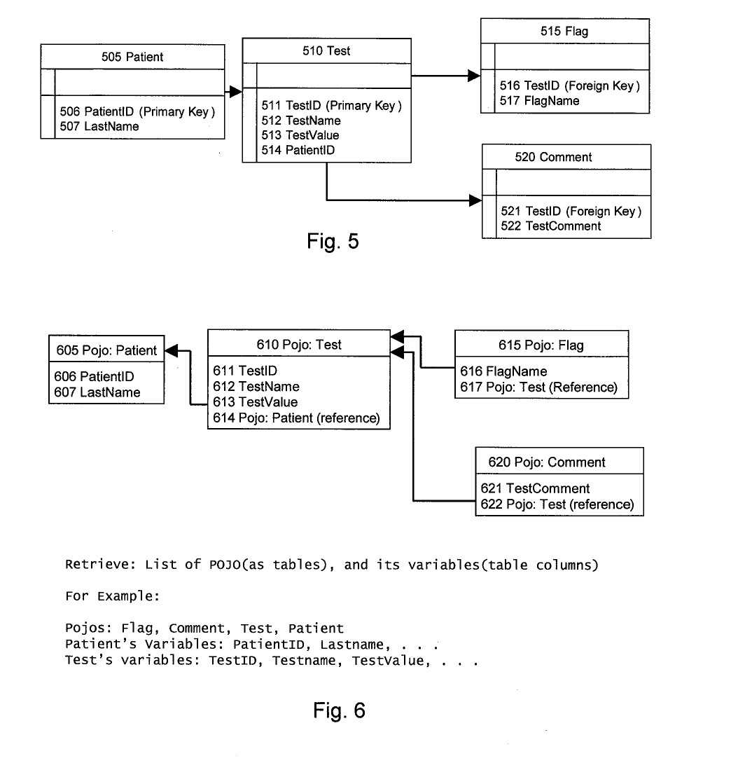

FIG. 5 shows a sample database structure of the type known in the art, comprising four tables: Patient Table 505; Test Table 510; Flag Table 515; and TestComment Table 520. Each of these tables comprises one or more columns. For example, Patient Table 505 comprised two columns: PatientID Column 506 and LastName Column 507; and Test Table 510 comprises four columns: TestID Column 511, TestName Column 512, TestValue Column 513, and PatientID column 514.

In a preferred embodiment, Database Connection Engine module 310 uses an object/relational persistence and query service such as Hibernate to create a Plain Old Java Object (POJO) for each table in the database. For example, with reference to FIG. 6, one POJO is created for each of the four database tables, including: POJO:Patient 605; POJO:Test 610; POJO:Flag 615; and POJO:Comment 620. Database Connection Engine module 310 uses the metadata from each of the Hibernate objects to determine the variables for each object, where the variables correspond to columns in the tables. For example, POJO:Patient 605 includes PatientID Variable 606 and LastName Variable 607, and POJO:Flag 615 includes FlagName Variable 616 and Test Variable 617.

In a preferred embodiment, Database Connection Engine module 310 uses the variables to identify the data type. If the data type of the variable is a POJO, the variable will point to another POJO, in which case a recursive step is performed to identify additional relationships. If the type of the variable is not a POJO, then no additional relationships exist.

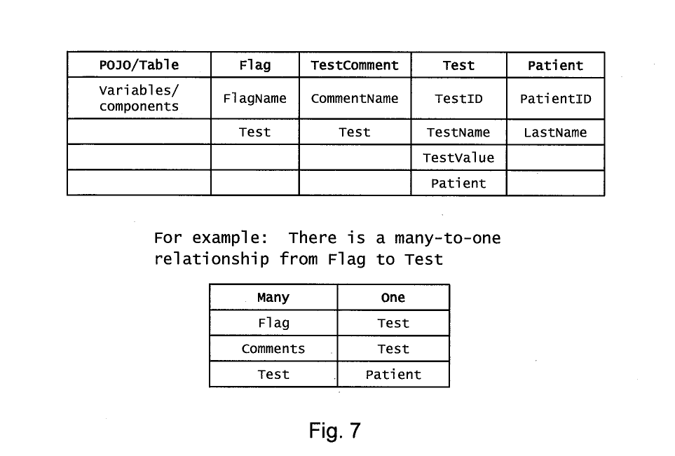

For example, with reference to FIGS. 6 and 7, object POJO:Flag 615 contains variable Test Variable 617, which is another POJO; object POJO:Comment 620 contains variable Test Variable 622, which is also a POJO, and POJO:Test 610 contains variable Patient Variable 614, which is also a POJO. As shown in FIG. 7, then, there is a many-to-one relationship between POJO:Flag 615 and POJO:Test 610, between POJO:Comment 620 and POJO:Test 610, and between POJO:Test 610 and Patient Variable 614.

Database Connection Engine module 310 uses the relationships (many-to-one, many-to-many, etc.) to construct possible join paths. Database Connection Engine module 310 determines the set of tables that have POJO objects but are not referenced by other POJO objects. These tables are termed top-level tables. With further reference to FIG. 7, then, the top-level tables are Flag and Comment.

Starting with the top-level tables, then, Database Connection Engine module 310 constructs a join path by following the many-to-one relationship. With further reference to FIG. 7, then, and top-level tables Flag and Comment, an example set of join paths are as follows:

Flag.Test+Test.Patient=Flag.Test.Patient

Comment.Test+Test.Patient=Comment.Test.Patient

The join paths are expressed in dot notation, and, in a preferred embodiment, are used to form HQL statements representing rules and actions.

2. HQL Queries, Rules and Actions

As described above, Database Connection Engine module 310 uses the join paths, expressed in dot notation, to form Hibernate HQL statements to represent queries, rules and actions. The HQL statement in this example is assembled from three separate parts:

(1) “Select”—[Select fields . . . ]

(2) “From”—[From POJO names . . . ]

(3) “Where”—[Where field=?]

As used in the HQL statement, above, the fields are the join paths described previously, expressed in dot notation. The join paths, however, are not displayed to the end user. Instead, Database Connection Engine module 310 creates aliases for each of the join paths, and the aliases are presented to the user through GUI module 320.

Database Connection Engine module 310 derives the aliases from the table/POJO and column/variable names. For example,

Column/Variable TestName in Table/POJO Test is aliased to “Test Name,”

Column/Variable FlagName in Table/POJO Flag is aliased to “Flag Name”

Column/Variable LastName in Table/POJO Patient is aliased to “Patient Name”

In addition to providing a more intuitive name to the end user, aliasing is useful for connecting multiple databases with different schemas. If the aliasing remains the same, and the database, or schema change, the Rules and Actions do not need to be rewritten because this level of abstraction decouples GUI module 320 from the database by re-writing the HQL statements.

The user selects the input fields and input values to query using GUI module 320. Database Connection Engine module 310 uses these input fields and input values to ultimately create an HQL statement.

In the following example, assume a user wanted to create a query to find all patient names, and specifically those who had a test of CO2 run. The algorithm to generate the HQL statements, formed from the three separate parts (“Select,” “From,” and “Where”) is as follows:

First, using GUI module 320, the user selects fields using the aliases. In this example, the aliases are “Patient Name” and “Test Name,” and the user-selected value for “Test Name” is ‘CO2.’ Second, a pseudo-HQL statement is generated. For this example, the pseudo-HQL statement is as shown in Table 1:

TABLE 1

| Pseudo-HQL Statement: | How determined: |
|---|---|
| Select “Patient Name” | Chosen by the user, via GUI module |
| | 320, using the aliased fields |
| From [tables detected by Database | Tables determined using the |
| Connection Engine module 310] | algorithm described below |
| Where “Test Name” = ‘CO2’ | Chosen by the user, via GUI module |
| | 320, using the aliased fields. |

Third, the three parts of the HQL statement (“Select,” “From,” and “When”) are formed from the pseudo-HQL statement, using the aliased fields. This query may also be saved as XML, to be used with other applications, such as a third party or proprietary report-generating program.

(i). “Select”

Continuing with the example above, then, the “Select” part of the HQL Statement is translated from the pseudo-HQL as follows:

Select “Patient Name”=>Select Patient.LastName

As previously described, the “Patient Name” selected by the user is the alias for Patient.LastName.

(ii). “From”

Database Connection Engine module 310 builds the “From” part of the HQL statement using the information generated during the “reverse-engineering” process described above. Specifically, Database Connection Engine module 310 had previously determined the list of POJO objects, their relationships, and the list of the variables contained in each POJO.

First, for each of the objects selected by the user via GUI module 320 (“Patient Name” and “Test Name”), Database Connection Engine module 310 traverses the list of all POJO objects created previously, and identifies the list of POJOs required for the query. Then, using the join paths defined previously, Database Connection Engine module 310 joins the POJO objects by identifying the list of matching paths for each alias selected by the user.

In this example, the “Patient” and “Test” POJO objects are required for the query. In a preferred embodiment, by modeling the algorithm after the Associative Law in Boolean algebra, [If (A and B) and (B and C) then (A and C)], Database Connection Engine module 310 joins the two tables, “Patient” and “Test,” to form the path. Note, however, that the present invention is not limited to using an algorithm modeled after the Associative Law, and other algorithms, including but not limited to algorithms based on graph theory, such as the Dijkstra shortest path algorithm, and the Kruskal and Prim minimal spanning tree algorithms, are also suitable and within the scope of the invention.

Continuing with the example, the Paths are:

Path1=Flag>Test>Patient

Path2=Comment>Test>Patient

Both Path1 and Path2 contain the POJOs needed for the query, and the matching path, by taking the sub-paths, is

Test>Patient

The “From” part of the pseudo-HQL statement, then is:

“From Test right join Patient”

The corresponding HQL statement is then created from the pseudo-HQL statement combining the detected paths with HQL's required variables of “test” and “patient,” as follows:

“From Test test right join Test.Patient patient”

(iii). “Where”

The “Where” part of the SQL Statement is translated from the pseudo-HQL as follows:

Where “Test Name”=‘CO2’=>Where Test.TestName=‘CO2’

As previously described, the “Test Name” selected by the user is the alias for Test.TestName, and the user-selected value for “Test Name” is ‘CO2.’

(iv). HQL Statement

Continuing with the example, the resulting HQL statement is as follows:

Select Patient.LastName

From Test test right join Test.Patient patient

Where Test.TestName=‘CO2’

### II. GUI

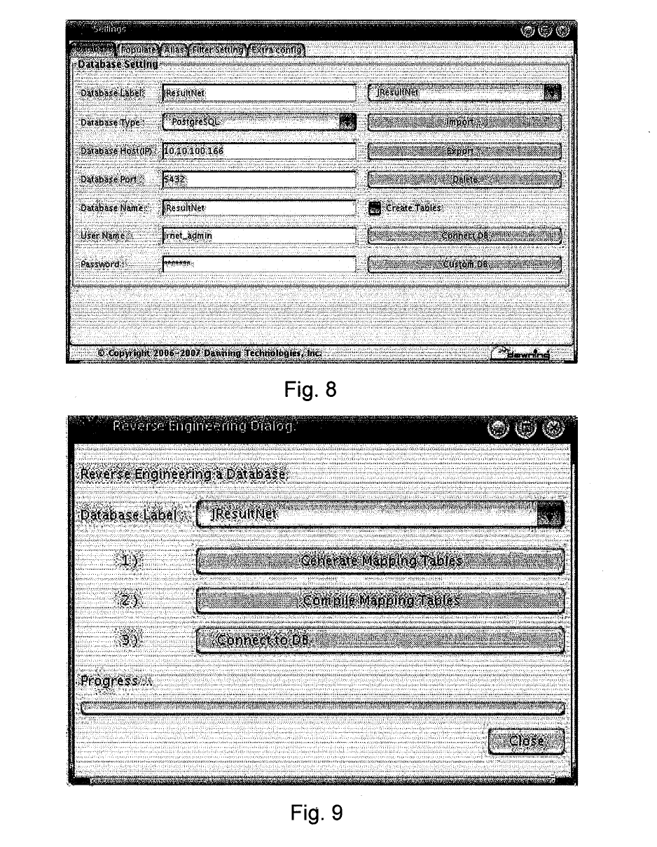

Referring to FIGS. 3 and 4, GUI module 320 allows a user to change the aliases, query the database, build custom rules and corresponding database actions, and view the results of the queries and resulting database actions. In a preferred embodiment, FIGS. 8 through 38, illustrate a set of user interface display in accordance with the rules-based data mining system of the present invention. The invention is not limited to these specific displays, however, nor is the invention limited to the specific methods of input or selection, such as menus or text boxes, that are shown in the displays.

In a preferred embodiment, as shown in FIG. 8, a user may configure a database connection. The following functions may be performed from this display: entering a database label; selecting a database type; entering a database host IP address; entering a database port number; entering a database name; entering a user name and password; saving a default database connection; connecting to a custom database; importing previous settings; exporting previous settings; and connecting to a database. This list is not intended to be limiting, and additional database management functions are also suitable and within the scope of the invention.

In a preferred embodiment, as shown in FIG. 9, a Reverse Engineering Dialogue window will be displayed if the user elects to set up a custom database.

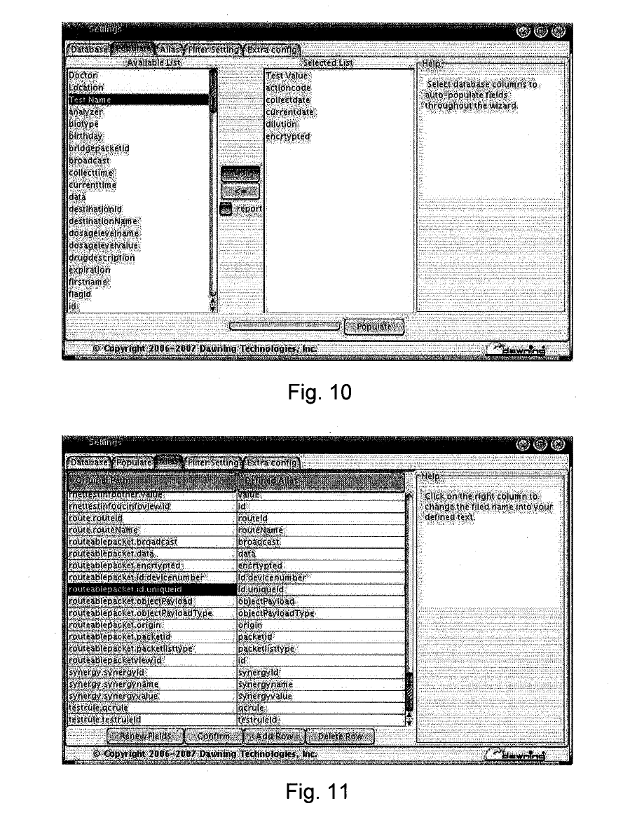

In a preferred embodiment, as shown in FIG. 10, a user may choose fields from the custom database to auto-populate with values. These values are then used when setting up queries. The Auto-Populate window provides drop-down menus with all available values for a particular field.

In a preferred embodiment, as shown in FIG. 11, an Alias Section display permits a user to modify the aliases generated by Database Connection Engine module 310. The Alias Section window also displays the join paths, expressed in dot notation.

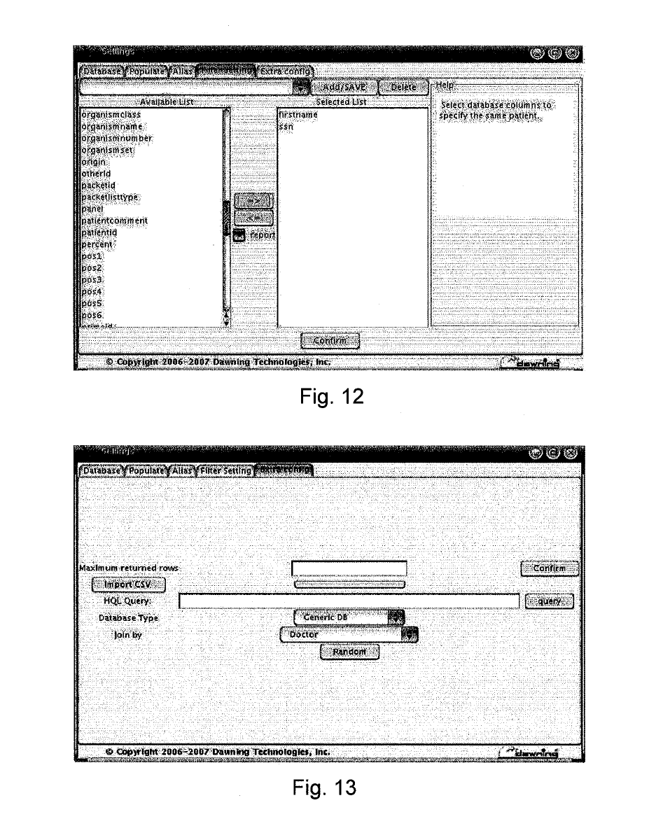

In a preferred embodiment, as shown in FIG. 12, a Filter Selection display permits the user to choose specific fields to be used in a query. In the example shown in FIG. 12, the Filter Selection display permits the user to choose which fields will be used to determine a “same patient” query. For example, a “same patient” query may require the values in the “firstname” and “ssn” fields to be the same.

In a preferred embodiment, as shown in FIG. 13, an Extra Configuration display provides additional settings that may be used to query databases, including, but not limited to: the number of rows to be returned, the database type, and one or more custom SQL statements.

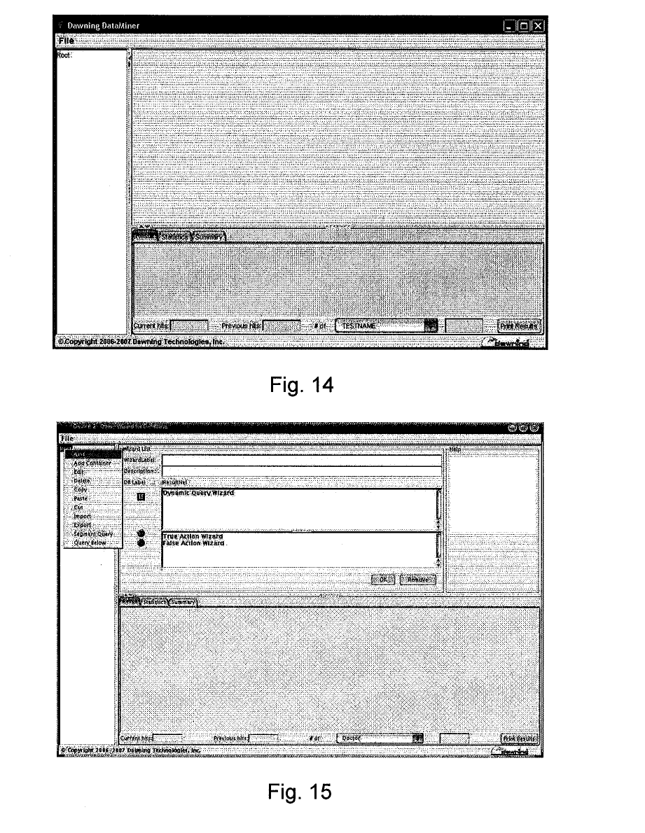

In a preferred embodiment, as shown in FIG. 14, a Dynamic Query Wizard: First View display will be presented to the user after GUI module 320 is started.

In a preferred embodiment, as shown in FIG. 15, an Add Dynamic Query Wizard View display will be presented to the user if “Root” is selected from the Dynamic Query Wizard: First View display shown in FIG. 14. The following functions may be performed from this display: entering a title (Wizard Label) and description for the query; select the Dynamic Query Wizard; select the True Action Wizard; and select the False Action Wizard. This list is not intended to be limiting, and additional query functions are also suitable and within the scope of the invention.

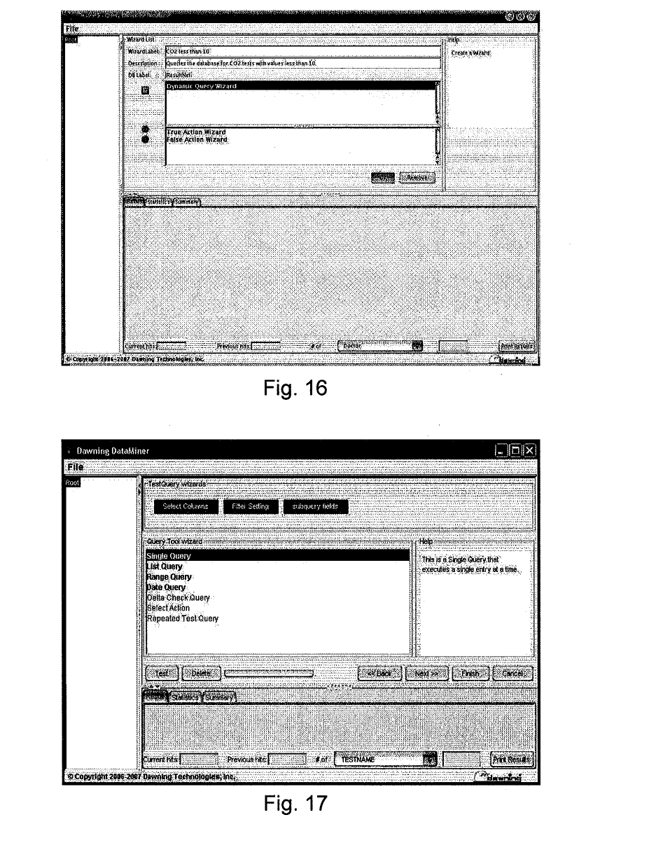

In a preferred embodiment, FIG. 16 shows the Add Dynamic Query Wizard View display of FIG. 15 with the Wizard Label and Description fields entered.

In a preferred embodiment, as shown in FIG. 17, a Query Tool Wizard display permits a user to choose from available query wizards including but not limited to: Single Query; List Query; Range Query; Date Query; Delta Check Query; and Repeated Test Query.

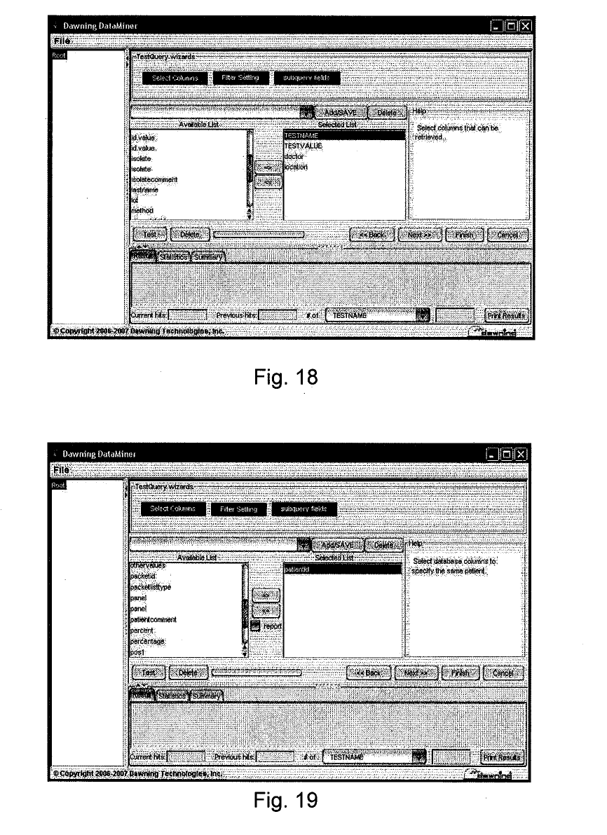

In a preferred embodiment, as shown in FIG. 18, the Dynamic Query Wizard provides a pre-configured display, Select Columns, which shows the database fields that represent the user's query fields. For example as shown in FIG. 18, if the user selects “TESTNAME” and “TESTVALUE,” the results from these fields will be displayed after the query is executed.

In a preferred embodiment, as shown in FIG. 19, the Dynamic Query Wizard provides a pre-configured display, Filter Settings, which allows a user to select filtering fields from the available database fields. For example, as shown in FIG. 19, the user may select “patientid” in order to specify the same patient.

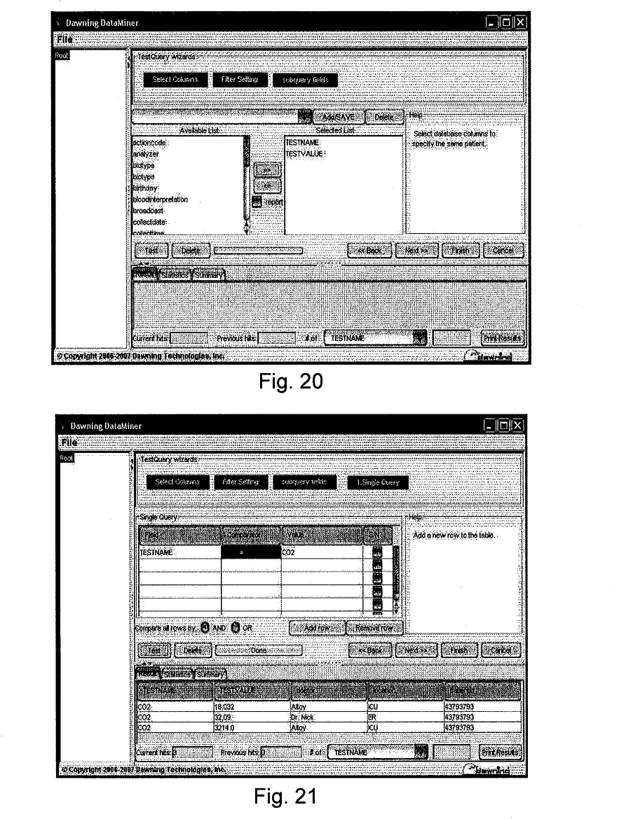

In a preferred embodiment, as shown in FIG. 20, the Dynamic Query Wizard provides a pre-configured display, Query Fields, which allows a user to select fields for a sub-query.

In a preferred embodiment, as shown in FIG. 21, the Single Query display allows a user to add a single condition field for the Query Wizard. This display also permits a user to combine several conditions with logical comparison operators, or logical comparators, including, but not limited to, AND and OR.

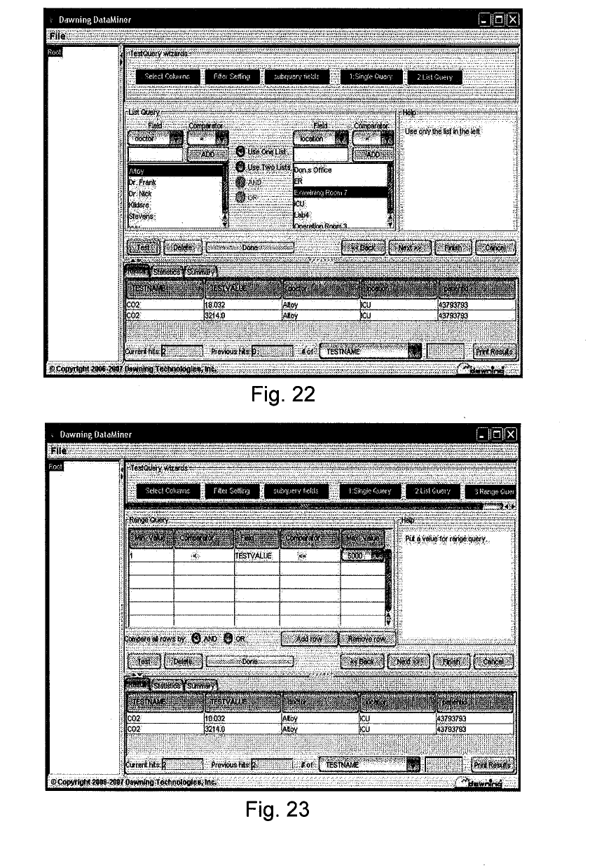

In a preferred embodiment, as shown in FIG. 22, the List Query display allows a user to query multiple fields using comparators, and to compare the data from two fields. In other embodiments, a user may compare data from two or more fields.

In a preferred embodiment, as shown in FIG. 23, the Range Query display allows a user to query multiple fields using range comparison values. This display also allows a user to specify multiple condition fields using logical comparators, including, but not limited to, AND and OR.

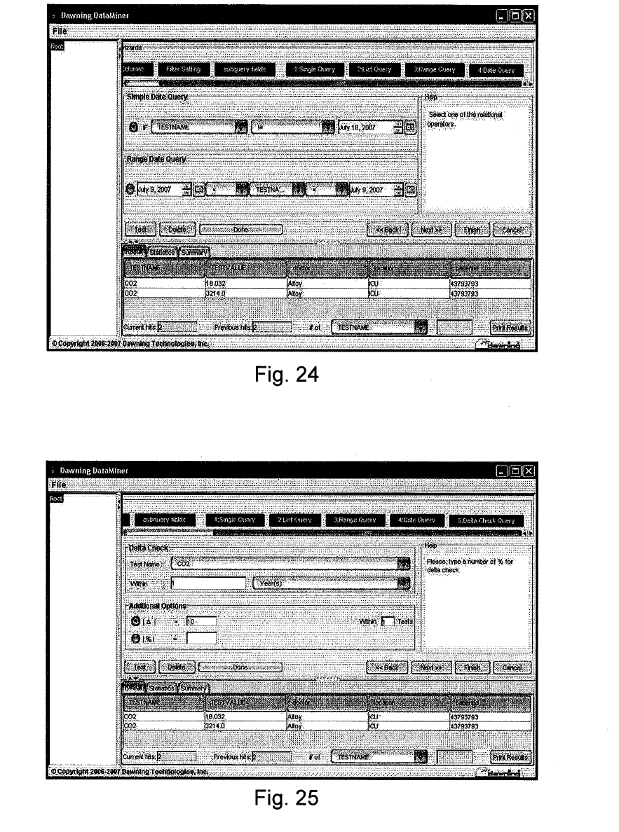

In a preferred embodiment, as shown in FIG. 24, the Date Query display allows a user to query a database field using a single date or a range of dates.

In a preferred embodiment, as shown in FIG. 25, the Delta Check Query display allows a user to perform a delta check query of a database field.

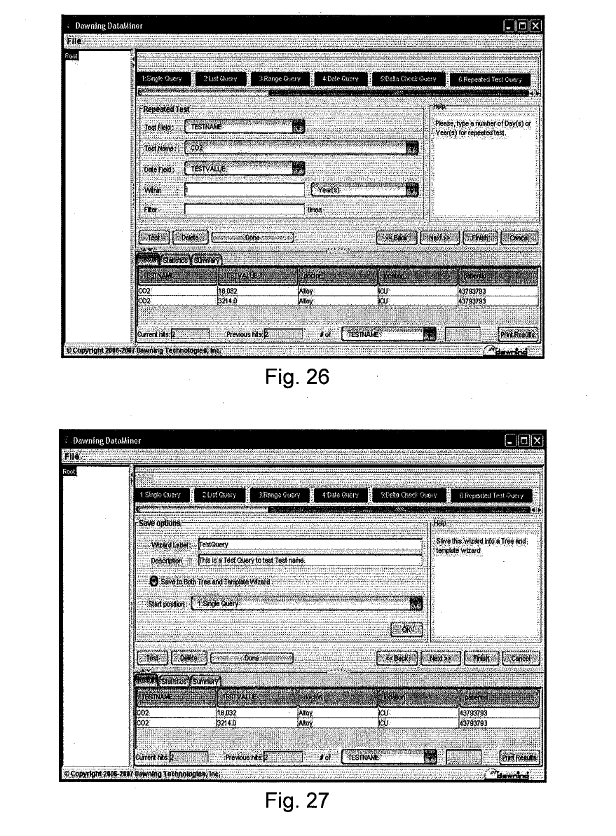

In a preferred embodiment, as shown in FIG. 26, the Repeated Test Query display allows a user to select repeated tests using a test field, test name, date field, and range, although other test parameters could be used and are within the scope of the invention.

In a preferred embodiment, as shown in FIG. 27, the Save Options display allows a user to save queries with a label, such that queries can be retrieved and executed at a later date.

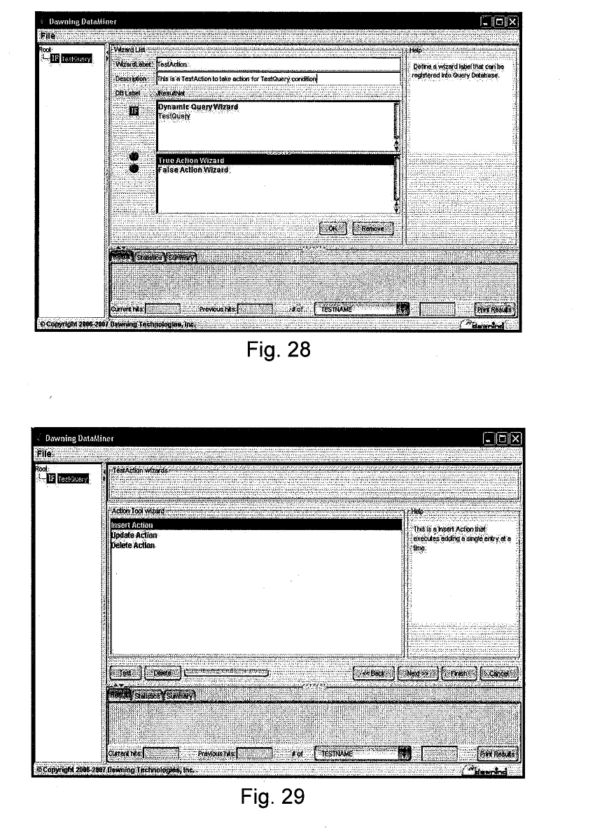

In a preferred embodiment, as shown in FIG. 28, the True Action Wizard display allows a user to build a query to be executed when the dynamic query execution returns “true.”

In a preferred embodiment, as shown in FIG. 29, the Action Tool Wizard display allows a user to select available actions, including, but not limited to, “Insert,” “Update,” and “Delete” actions.

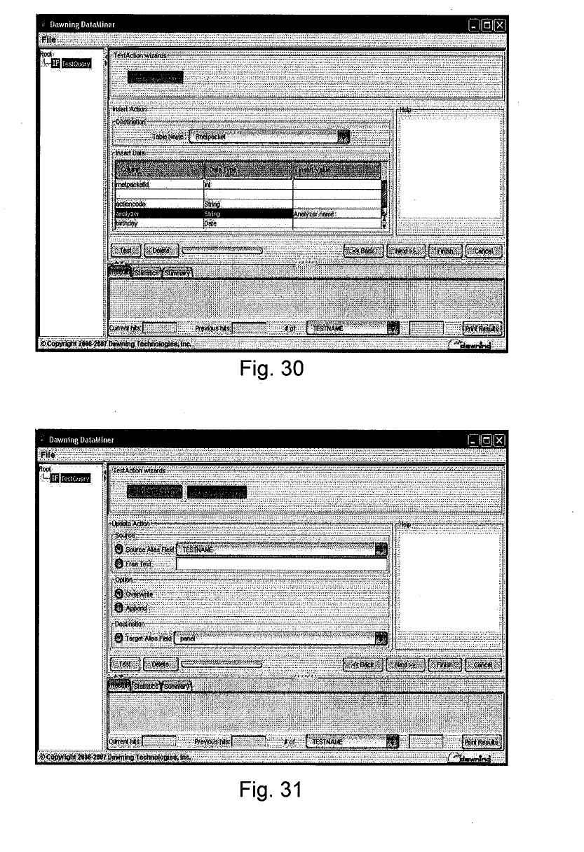

In a preferred embodiment, as shown in FIG. 30, the Insert Action display allows a user to specify a table name and a set of field values.

In a preferred embodiment, as shown in FIG. 31, the Update Action display allows a user to specify three sets of data: “Source,” “Option,” and “Destination.” “Source” includes two fields, “Source Alias,” which is automatically populated, and “Free Text.” “Option” includes “Overwrite” and “Append.” “Destination” includes a target alias field.

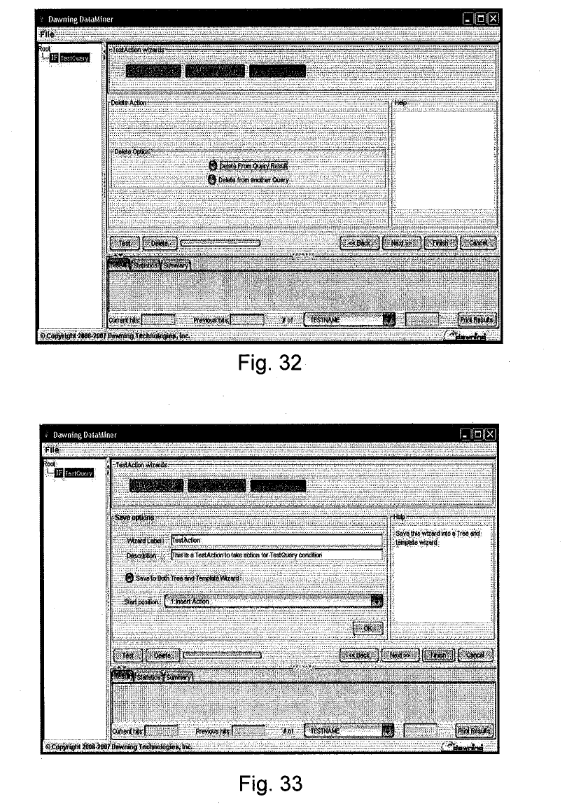

In a preferred embodiment, as shown in FIG. 32, the Delete Action display allows a user to delete a query result or a query.

In a preferred embodiment, as shown in FIG. 33, the Save Options display allows a user to save a true action query as a template that can be reused or modified at a later date.

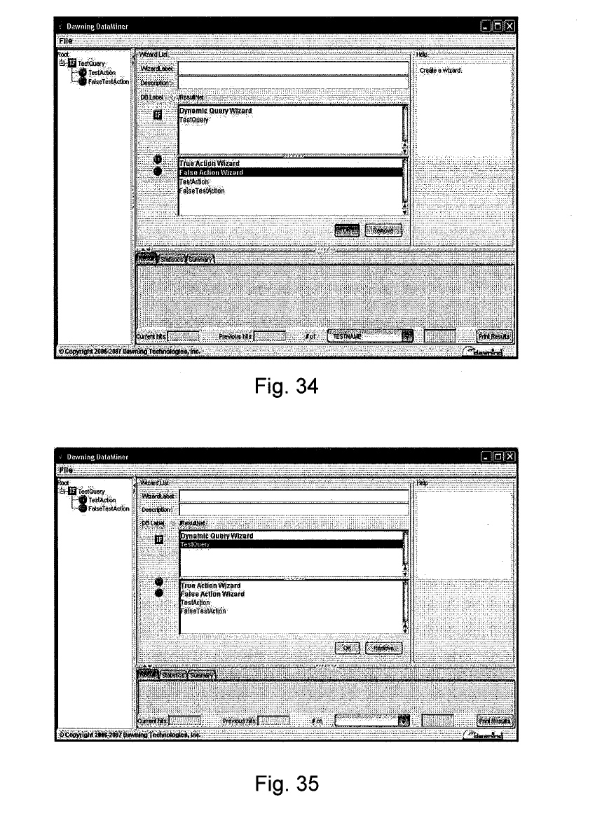

In a preferred embodiment, as shown in FIG. 34, the False Action Wizard display allows a user to save a false action query as a template that can be reused or modified at a later date.

In a preferred embodiment, as shown in FIG. 35, the Template Wizard display allows existing templates wizards to be reused or modified from Wizard List.

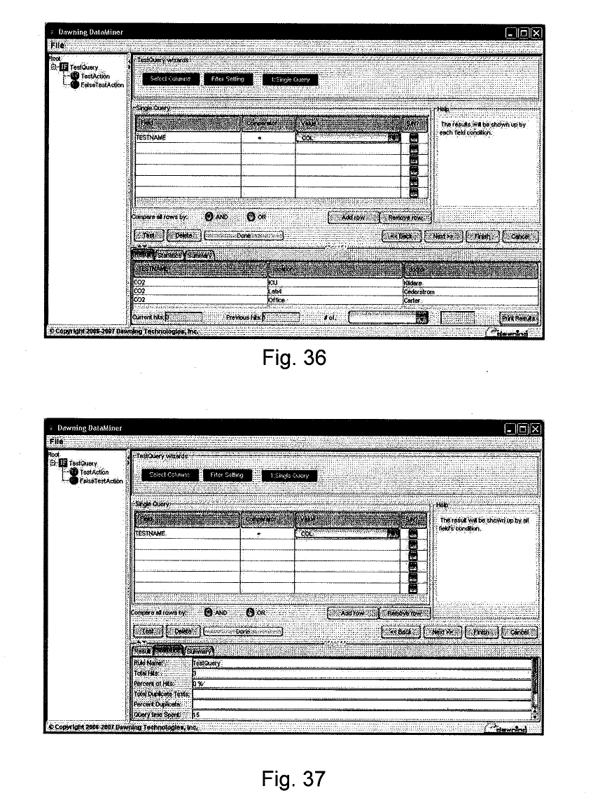

In a preferred embodiment, as shown in FIG. 36, the Modify Template Wizard display allows a user to modify existing templates wizard.

In a preferred embodiment, as shown in FIG. 37, the Statistics View display allows a user to view statistics data for the Result View after the query is executed, including but not limited to: “Rule Name”, “Total Hits”, “Percent of Hits”, “Total Duplicate Tests”, “Percent Duplicate”, and “Query Time Spent” are displayed.

### III. API

With further reference to FIGS. 3 and 4C, in additional embodiments the present invention comprises an API 380, which may be used by a computer program 390 to interact with Database Connection Engine module 310, and allows the computer program to execute queries and integrate the results of these queries into computer program 390's internal system. The queries and/or the results may be saved in XML format and stored in a file or placed in a data stream to be used by computer program 390. The API thus permits a computer program to take advantage of the features provided by Database Connection Engine module 310.

In a preferred embodiment, API 380 is implemented in Java, and supports Java 2 Standard Edition (J2SE) 1.4, although other versions of Java, and other programming languages, including but not limited to C++ and C, are also suitable and within the scope of the invention. Note that each implementation of API 380 can vary depending on the requirements of the specific programming language.

Similarly, in a preferred embodiment, API 390 supports a computer program written in Java, although other programming languages, including but not limited to C++ and C, are also suitable and within the scope of the invention. The types of computer programs that can interact with the underlying database are not limited to any particular application or programming language, and can be of any type, such as a Windows DLL, or a third-party database application.

Within API 380, a saved query is referenced by a unique indentifying name, for example, “MyQueryName.” API 380 provides a function, for example, ExecuteQuery( ), that operates on or uses the saved query and returns the results of the query as a character string, such as sResults, as follows:

String sResults=ExecuteQuery (“MyQueryName”);

Alternatively, the query and/or the results of the query can be in XML format, and can be filed-based. Additionally, ExecuteQuery( ) can be extended to format and/or interpret the results. For example, the following additional functions can be provided:

ExecuteQueryAsXML( )—to execute the query in XML format;

ExecuteQueryAndSaveToFile( )—to save the results of the query in a file;

Note that the invention is not limited to these examples. API 380 can also provide functions to support setting up or closing the connection between computer program 380 and Database Connection Engine module 310. Examples of such functions include, but are not limited to:

OpenRulesQuery( )—to open a connection to Database Connection Engine module 310; and

Close RulesQuery( )—to close a connection to Database Connection Engine module 310;

Additional API functions, to support custom features of computer program 390, are also suitable and within the scope of the invention.

The claims should not be read as limited to the described order or elements unless stated to that effect. Therefore, all embodiments that come within the scope and spirit of the following claims and equivalents thereto are claimed as the invention.

What is claimed:

1. A system for forming a statement for a database comprising:
a database stored on a computer-readable medium and having a schema;
a database connection module, for translating at least a portion of the schema into one or more objects and variables, where at least one object is associated with at least one variable, and creating a corresponding alias for the object and associated variable; and
a user interface module, for displaying the corresponding alias, and accepting at least one user input associated with the corresponding alias;
wherein the database connection module receives the user input, and forms a database statement from the corresponding alias and the user input.

2. The system of claim 1, where the database is a relational database.

3. The system of claim 1, where the database statement is a Hibernate Query Language (HQL) statement.

4. The system of claim 1, where the database statement is an Extensible Markup Language (XML) statement.

5. The system of claim 1, where the user interface module is a graphical user interface (GUI) module.

6. A method for forming a statement for a database, where the database has at least one table and the table has at least one column, comprising the steps of:
creating an object for the table;
determining a variable for the object, where the variable corresponds to the column in the table;
constructing a join path using the object and the variable;
creating an alias for the join path;
accepting at least one input associated with the alias; and
forming a database statement from the input.

7. The method of claim 6, where the object created is a Plain Old Java Object (POJO).

8. The method of claim 6, where the variable for the object is determined using the object's metadata.

9. The method of claim 6, further comprising the step of identifying a data type for the variable, and using the data type to create the join path.

10. The method of claim 6, where the database statement is a Hibernate Query Language (HQL) statement.

11. The method of claim 6, where the database statement is an Extensible Markup Language (XML) statement.

12. The method of claim 6, further comprising the step of displaying the alias.

13. The method of claim 12, further comprising the step of displaying the join path.

14. The method of claim 6, where the input comprises one or more input fields and one or more input values, and the database statement is a database query statement formed from the input fields and the input values.

15. The method of claim 6, where the database query statement is formed from the input and the join path associated with the alias.

16. A computer-readable medium comprising one or more computer-executable instructions for:
creating an object for a table in a database;
determining a variable for the object, where the variable corresponds to a column in the table;
constructing a join path using the object and the variable;
creating an alias for the join path;
accepting at least one input associated with the alias; and
forming a database statement from the input.

17. The computer-readable medium of claim 16, further comprising computer instructions for displaying the alias and forming the database statement from the alias.

18. A computer system comprising one or more computer processors, system memory, and one or more physical computer-readable media having stored thereon computer-executable instructions, which, when executed, perform a method comprising:
creating an object for a table in a database;
determining a variable for the object, where the variable corresponds to a column in the table;
constructing a join path using the object and the variable;
creating an alias for the join path;
accepting at least one input associated with the alias; and
forming a database statement from the input.

19. The computer system of claim 18, where the method further comprises displaying the alias and forming the database statement from the alias.

20. A system for forming a statement for a database comprising:
a database stored on a computer-readable medium and having a schema;
a database connection module, for translating at least a portion of the schema into one or more objects and variables, where at least one object is associated with at least one variable, and creating a corresponding alias for the object and associated variable; and
an application programming interface, for providing the corresponding alias to a computer program, and accepting a query associated with the corresponding alias from the computer program;
wherein the database connection module receives the query, and forms a database statement from the corresponding alias and the query.
